(19) United States
(12) Patent Application Publication
(10) Pub. No.: US 2017/0316456 A1
(43) Pub. Date: Nov. 2, 2017

(54) BUSINESS-TO-BUSINESS (B2B) TO CONSUMER (B2B2C) PROCESSING

(71) Applicant: NCR Corporation, Duluth, GA (US)

(72) Inventors: Yehoshua Zvi Licht, Alpharetta, GA (US); Donald Davidson, Keller, TX (US); Robert Andrew Kingslyn, San Diego, CA (US); Joseph Arnold White, Encinitas, CA (US)

(21) Appl. No.: 15/142,019

(22) Filed: Apr. 29, 2016

(51) Int. Cl. G06Q 30/02; G06Q 30/00

(52) U.S. Cl. CPC G06Q 30/0253; G06Q 30/01; G06Q 30/0255

(57) ABSTRACT

A shared service supports interfaces for interacting with at least two different business systems and providing customer-relationship management processing that is shared between the two different business systems. The shared service also provides interfaces for interacting with customer operated devices for delivering recommendations and promotions to specific customers based on anticipated patterns of the specific customers identified in a shared history between the two business systems.

### BACKGROUND

Today each business has its own business systems for Customer-Relationship Management (CRM) and campaign management for purposes of establishing customer loyalty and providing promotions specific to that business and its systems over certain electronic communication channels.

Essentially, businesses closely guard there CRM and campaign management, which actually inhibits a customer's experience because the customer has to deal with each business and that business's systems independently. Moreover, because a business system lacks any real-time ability for interacting with a different business system the sharing of any customer activity is stale even when business systems do support some form of sharing. That is, the best time for promoting a good or service to a customer is when that customer is engaged or located somewhere that the customer is most likely to want the good or service. However, existing B2B approaches lack real-time customer coordination and sharing.

Additionally, businesses hold their customer data and marketing data as valued secrets and therefore are averse to any attempt to share customer information or CRM information with another different business, even when the two business are not competitors with one another. This present situation ensures that businesses are not even addressing whether or not sharing customer information or CRM information is a profitable investment.

Businesses do engage in electronic Business-to-Business (B2B) transactions but this is limited to commercial transactions between two businesses. Businesses also engage in electronic Business-2-Customer (B2C) transactions but this is limited to one-business knowledge of a specific customer to which that business is marketing to.

In fact, no one in the industry engages in B2B to Consumer (B2B2C) transactions.

### SUMMARY

In various embodiments, methods and a system for Business-to-Business (B2B) to Consumer (B2B2C) processing are presented.

According to an embodiment, a method for B2B2C processing is provided. Specifically, in an embodiment, transaction data is received for a customer in real-time from a first business system. Next, a recommendation or a promotion is obtained for a good or service that is available from a second business system based on the transaction data. Finally, the recommendation or the promotion is delivered to the customer.

### BRIEF DESCRIPTION OF THE DRAWINGS

FIG. 1A is a diagram of a system for Business-to-Business (B2B) to Consumer (B2B2C) processing, according to an example embodiment.

FIG. 1B is a diagram a sample architecture for practicing B2B2C processing according to an example embodiment.

FIG. 2 is a diagram of a method for B2B2C processing, according to an example embodiment.

FIG. 3 is a diagram of another method for B2B2C processing, according to an example embodiment.

FIG. 4 is a diagram of a system for B2B2C processing, according to an example embodiment.

### DETAILED DESCRIPTION

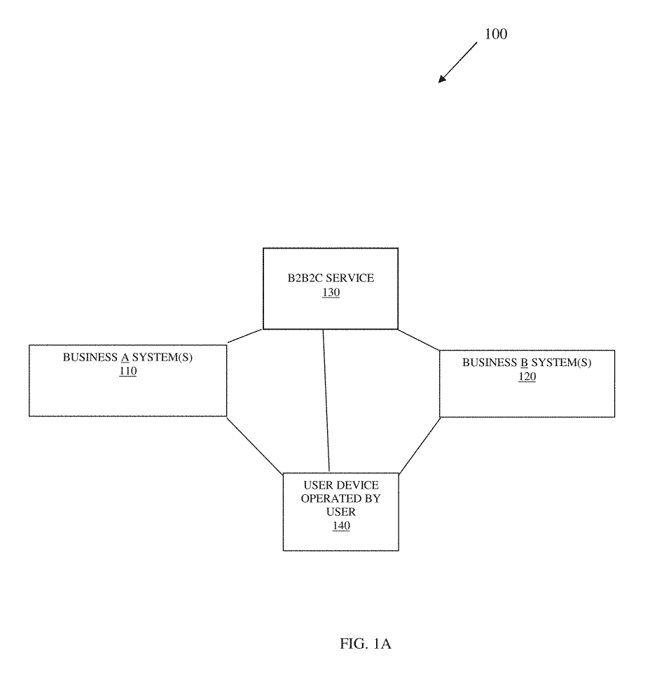

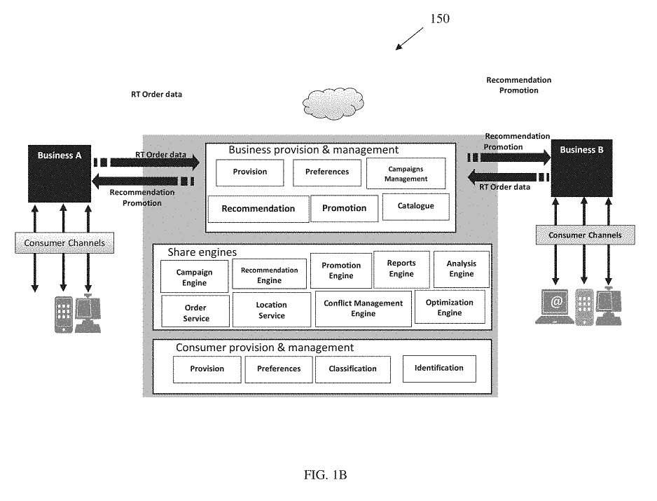

FIG. 1A is a diagram of a system 100 for Business-to-Business (B2B) to Consumer (B2B2C) processing, according to an example embodiment. The system 100 is shown schematically in greatly simplified form, with only those components relevant to understanding of one or more embodiments (represented herein) being illustrated. The various components are illustrated and the arrangement of the components is presented for purposes of illustration only. It is to be noted that other arrangements with more or less components are possible without departing from the B2B2C processing presented herein and below.

Moreover, various components are illustrated as one or more software modules, which residing in non-transitory storage and/or hardware memory as executable instructions that when executed by one or more hardware processors perform the processing discussed herein and below.

The techniques, methods, and systems presented herein and below for B2B2C processing can be implemented in all, or some combination of the components shown in different hardware computing devices having one or more hardware processors.

The system 100 includes a first business system(s) (business “A” system) 110, a second and different business system(s) (business “B” system) 120, a novel B2B2C service 130, and a user-operated device operated by a user (customer or consumer) 140.

As an initial configuration, an interface between business A system 110 and the B2B2C service 130 is exposed from the B2B2C service 130 to the business A system(s) 110 for purposes of the business A systems defining a schema and schema elements within the schema for data transferred from the business A system to the B2B2C service 130 and for defining what types of data the business A system(s) can recognize and process. This is done in a similar manner between the business B system(s) 120 and the B2B2C service 130.

A variety of operating scenarios can occur with system 100, some of which now follow.

When a customer performs a transaction with business A using a consumer-operated device 140 or a POS terminal associated with a Business A system, the transaction data from Business A system 110 is sent in real time to the B2B2C service 130 using the exposed interface between Business A system(s) 110 and the B2B2C service 130 (which was configured as noted above, such that the B2B2C service 130 can obtain a customer identifier from the transaction data and other details from the transaction data, such as products purchased, business system A 110 transaction terminal identifier, date and time, clerk identifier for any clerk than may be assisting with the transaction at the terminal, and the like.

The B2B2C service 130 maintains a history of transactions for the consumers of business A and business B. This history can be pre-analyzed to reveal patterns for a particular consumer, such as every Monday the consumer visits business A and purchases bread, milk, and eggs within a certain time of day. Other details of the customer may also be known such as the customer's home address, which can be communicated from any loyalty system of business A system through the interface to the B2B2C service 130. This is but one example of one pattern, any discernable repeatable pattern of behavior for the consumer can be identified and housed for recall by the B2B2C service 130 during real-time transaction processing by the consumer with business A.

Suppose the above pattern for milk, eggs, and bread are detected for the consumer transacting at business A. Suppose also that the home address for the consumer is known as discussed above. The B2B2C service 130 can use location data for the terminal identifier of the transaction from business A to resolve a physical location of the transaction and, then, process that physical location as a starting point to generate a route from business A to the consumer's home address (ending point). This can then be utilized by business B, which appears along the generated route to push a promotion to the consumer during or at the conclusion of the transaction with business A. The B2B2C service 130 identifies promotions available at business B (also communicated through the interface from business B to the B2B2C service 130) and identifies business B along the route of the consumer from business A to the consumer's home. The B2B2C service 130 uses the interface to push business B's promotion to the terminal in a format that the terminal is configured to handle, such as printing on a receipt the business B promotion.

These shared promotions between business A and business B may also be managed through authorizations through both business A and business B communicated to the B2B2C service 130. This can ensure and address issues that business A may have with allowing business B to offer a promotion to business A's customer when business A and business B compete with one another for the same or similar products or goods. In fact, the authorizations may be restricted by business A to allow business B to offer promotions to business A's customers for goods or services that business A does not sell or offer. The similar limitations may be imposed by business B when a customer is transacting at a terminal of business B and a promotion is offered for a good or service of business A. This provides control to the businesses for ensuring that the businesses are not losing revenue that might otherwise be available to the businesses.

In another scenario, when a consumer is transacting with business A system(s) using the consumer-operated device, the transaction data is communicated in real time in the same manner to the B2B2C service 130; however, this time the transaction may also provide an identifier for the consumer-operated device, such as a phone number (in one example). The promotion can then be directly pushed from B2B2C service 130 to the consumer-operated device, as a Short Messaging System (SMS) text message, a mobile application message, etc.

In still another scenario, the consumer may be transacting with a terminal of business A over a POS terminal operated by the consumer or by a clerk of business A and the transaction data is communicated in real time from the business A system 110 to the B2B2C service 130. Here, the B2B2C service 130 may have a registered mobile phone number of mobile application registered to a mobile phone of the consumer and communicate the business B promotion directly to the consumer-operated device 140 (the phone or the mobile application). This is cross-channel (POS transaction with business system 110 (channel 1) and delivery of business B's promotion to a mobile device (channel 2)) promotion delivery and does not rely on communication of the promotion from any device or system associated with business A (exclusively handled by the B2B2C service 130) once notified of the transaction with business A system 110.

In addition to real time promotion deliver using B2B2C communications over a same or different channel, the B2B2C service 130 can provide sharing of campaign management and recommendations that are made to the consumers, which are shared between business A and business B and managed by the B2B2C service 130. That is, the B2B2C service 130 can combine campaign management data and promotions between business A and business B to make recommendations for promotions to the consumer, business A, and/or business B based on the consumer's identified patterns (such as known paths that the consumer takes, known habits in buying for the consumer, etc.).

Some of these additional features of the B2B2C service 130 are now discussed with reference to the FIG. 1B.

FIG. 1B is a diagram a sample architecture 150 for practicing B2B2C processing according to an example embodiment.

The architecture 160 includes: 1) a first business “A” systems (backend system and/or Point-Of-Sale (POS) terminals interfaced to the backend system), 2) a variety of consumer channels through which business A may interact with the business A systems through a variety of 3) consumer-operated devices (such as user-operated device 140, wearable processing device, laptop, phone, and/or desktop computer).

The architecture 160 also includes: 1) a second business “B” systems (backend system and/or Point-Of-Sale (POS) terminals interfaced to the backend system), 2) a variety of consumer channels through which business B may interact with the business B systems through a variety of 3) consumer-operated devices (such as user-operated device 140, wearable processing device, laptop, phone, and/or desktop computer).

Still further, the architecture 160 includes a cloud based, service based, and/or Software-as-a-Service (SaaS) system through which 1) the businesses A and B share customer tracking, monitoring, and marketing information about the customer, and through which 2) a customer-operated device may directly interact with the system.

In an embodiment, the shared service between the businesses A and B and the customer is the system 100.

The shared service includes a variety of services with three main architectural components: 1) business provision and management, 2) share engines, and consumer provision and management.

The business provision and management service includes sub-services for: provisioning, preferences, campaign management, recommendations, promotions, and catalogues. Each business (A and B), uses the interlace (discussed above with the B2B2C service 130) to register with the marketplace to: 1) identify provisions for promotions, such as types, sizes, amounts that each business is willing to provide, 2) preferences and areas of the registering business's domain (grocery, fast food, etc.), 3) share campaign management (authorizations for sharing with identified other businesses), 4) types of potential recommendations desired by the business for customers, and the like.

The share engines include sub-services for processing: a campaign engine, a recommendation engine, a promotion engine, a reports engine, an analysis engine, handing order service, location-based services, a conflict management engine, and an optimization engine. This layer and its subservices shares inter-business order data and campaign data between businesses to optimize recommendations based on conflict management and real time order data occurring between different channels (POS terminal, online, mobile, in-person, television, kiosk, desktop, etc.). Here, data regarding any particular customer as known by all the participating businesses and real time transaction data is combined to derive a recommendation and promotion for the consumer in a known or anticipated journey (path) for the consumer.

The consumer provision and management includes sub-services for: provisioning, preferences. classification, and identification. This layer provides processing for linking the businesses to a specific customer known to or anticipated to be traversing a known journey or pattern for that customer along with customer location and providing the customer with recommendations and promotions during that journey or pattern for those businesses.

The shared service (components in the middle of the architecture 150) permits sharing how and what recommendations are made to specific customers between businesses during a known or anticipated customer journey (path based on customer location) or pattern occurring with the customers. The journey or pattern can be derived from a history of transactions for the customers and other data known for the customers between the businesses (such as home address, work address, etc.). This can permit direct B2B2C recommendations and promotions and can permit building unified and united campaign management between sharing businesses for derived customer segments.

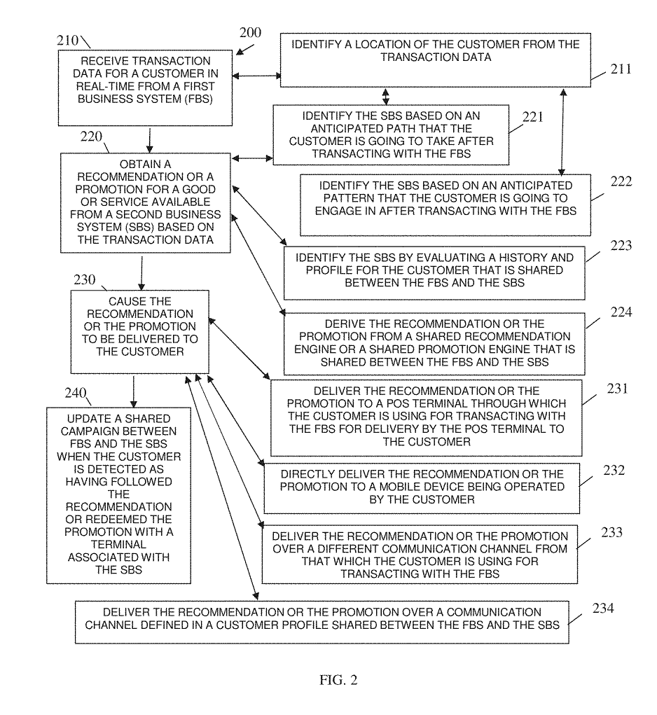

These and other embodiments are no discussed with reference to the FIGS. 2-4.

FIG. 2 is a diagram of a method 200 for B2B2C processing, according to an example embodiment. The software module(s) that implements the method 300 is referred to as a “B2B2C manager.” The B2B2C manager is implemented as executable instructions programmed and residing within memory and/or a non-transitory computer-readable (processor-readable) storage medium and executed by one or more hardware processors of a hardware computing device. The processors of the device that executes the B2B2C manager are specifically configured and programmed to process the B2B2C manager. The B2B2C manager has access to one or more networks during its processing. The networks can be wired, wireless, or a combination of wired and wireless.

In an embodiment, the device that executes the B2B2C manager is a server.

In an embodiment, the device that executes the B2B2C manager is a cloud processing environment having a variety of hardware devices logically organized as a single processing environment.

In an embodiment, the B2B2C manager is the B2B2C service 130.

In an embodiment, the B2B2C manager is the shared service depicted in the center of the architecture 150 of the FIG. 1B.

In an embodiment, the B2B2C manager is a combination of the B2B2C service 130 and the shared service depicted in the center of the architecture 150 of the FIG. 1B.

At 210, the B2B2C manager receives transaction data for a customer in real time from a first business system. The transaction data is received through an interface exposed by the B2B2C manager to the first business system. Moreover, the format and components of the transaction data are defined by a schema (which can be tag based to identify the components or field based to identify the components), and the B2B2C manager is configured to process the schema for parsing the transaction data and extract the components. Some components or elements in the transaction data can include: first business system terminal identifier, store identifier, transaction date and time, customer identifier, item identifiers for items purchased, dollar amount per item, total dollar amount for the transaction, any clerk identifier for any clerk that may be assisting in the transaction, and the like.

According to an embodiment, at 211, the B2B2C manager identifies a location of the customer from the transaction data. For example, the terminal identifier or store identifier may be linked to a specific geographical location. In some cases, the transaction data may also include a location reference (such as a zip code or address).

At 220, the B2B2C manager obtains a recommendation or a promotion for a good or service available from a second business system based on the transaction data. That is, assuming the preferences and authorizations are acceptable between the first business associated with the first business system and the second business associated with the second business system, the B2B2C manager can obtain or derive a specific recommendation or specific promotion for a good or service being offered to the customer while that customer is transaction with a POS terminal of the first business system (in real time or near real time).

According to an embodiment of 211 and 220, at 221, the B2B2C manager identifies the second business system based on an anticipated path or journey that the customer is expected to or going to take after transaction with the first business system. This can be done in a number of manners (some of which were discussed above), such as by detecting a pattern of movement (travel) for the customer in a transaction history maintained and shared between the two business systems, or such as by having a known home address or work address for the customer in a shared customer profile between the two business system and generating a route from the terminal of the first business system to the home address or the work address based on the time of day of the transaction.

In an embodiment of 211 and 220, at 222, the B2B2C manager identifies the second business system based on an anticipated pattern that the customer is going to engage in after transacting with the first business system. Here, the customer's shared B2B transaction history may reveal that there is a repeating pattern that the customer after purchasing gas at station X (first business) on Monday mornings, the customer then visits a fast food chain which varies from time to time and one of those fast food establishments is the second business.

In an embodiment, at 223, the B2B2C manager identifies the second business system by evaluating a history and profile for the customer that is shared between the first business system and the second business system, where that shared history and profile is maintained and managed by the B2B2C manager.

In an embodiment, at 224, the B2B2C manager derives the recommendation or the promotion from a shared recommendation or a shared promotion engine that is shared between the first business system and the second business system and maintained and processed for deriving recommendations and promotions by the B2B2C manager on behalf of both the first and second business systems.

At 230, the B2B2C manager causes the recommendation or the promotion to be delivered to the customer. That is, the B2B2C manager can directly deliver the recommendation or the promotion over an existing communication channel that the customer is using for transacting with the first business system or can deliver the recommendation of the promotion over a different communication channel from that which the customer is using for transacting with the first business system.

For example, at 231, the B2B2C manager delivers the recommendation or the promotion to a POS terminal through which the customer is using for transaction with the first business system for direct deliver by the POS terminal of the first business system to the customer (through POS terminal communication with a mobile device of the customer, through displaying on the POS terminal, and/or for printing on a receipt at a receipt printer of the POS terminal).

In another case, at 232, the B2B2C manager directly delivers the recommendation or the promotion over a different communication channel from that which the customer is using for transaction with the first business system. For example, the customer may be transacting with the first business system over a POS terminal that is a Self-Service Terminal (SST) and the B2B2C manager may deliver the recommendation or the promotion directly to a mobile phone of the customer during the transaction or in near-real time after the transaction when the customer is leaving the first business.

It is to be noted that although the previous embodiments have all discussed a customer transacting at a brick-and-mortar store of the first business, this does not have to be the case. For example, the customer may transaction over a mobile device (phone, laptop, wearable processing device, tablet, etc.) or a desktop computer with a web site (Internet store front) of the first business. In such a case, a mobile application processing on the mobile device of browser-based applet on the desktop browser may provide current physical location information for a location of where that device being operated by the consumer is at for performing some of the processing discussed above, such as the processing at 211 and 222.

In an embodiment, at 233, the B2B2C manager delivers the recommendation or the promotion to a mobile device being operated by the customer. This can be done through an API by sending application messages to a known mobile application processing on the customer's mobile device or through a SMS text message, which may include an image of the recommendation or the promotion (can be a Quick Response Code as well), a text readable version of the recommendation or the promotion, and/or a Uniform Resource Locator (URL) link that when activated initiates a browser application on the mobile device and traverses the browser to a website where the recommendation or the promotion is dynamically rendered for the customer on a display of the mobile device within a dynamically rendered web page.

According to an embodiment, at 234, the B2B2C manager delivers the recommendation or the promotion over a communication channel defined in a customer profile shared between the first business system and the second business system; the profile maintained, managed, and processed as needed by the B2B2C manager. Thus, the customer can be reached by the businesses over cross-channel communications, such that the businesses are essentially always capable of reaching the customer and in timely fashions that are likely to be most lucrative to the businesses.

In an embodiment, at 240, the B2B2C manager updates a shared campaign between the first business system and the second business system when the customer is detected as having followed the recommendation or redeemed the promotion with a terminal associated with or through interaction with the second business system. This ensures that the shared campaign engine can record successes for purposes of tuning future campaigns between the two businesses (for example demographic information for a customer segment targeted in the campaign may reveal a more fine-tuned customer segment for a future campaign).

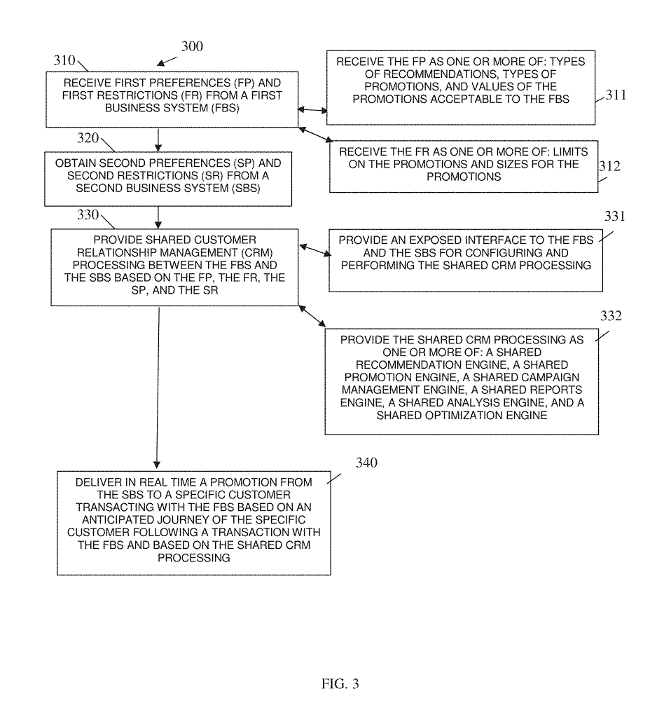

FIG. 3 is a diagram of another method 300 for B2B2C processing, according to an example embodiment. The software module(s) that implements the method 300 is referred to as a “B2B2C service.” The B2B2C service is implemented as executable instructions programmed and residing within memory and/or a non-transitory computer-readable (processor-readable) storage medium and executed by one or more hardware processors of a hardware device. The processors of the device that executes the B2B2C service are specifically configured and programmed to process the B2B2C service. The B2B2C service has access to one or more networks during its processing. The networks can be wired, wireless, or a combination of wired and wireless.

In an embodiment, the device that executes the B2B2C service is a server.

In an embodiment, the device that executes the B2B2C service is a proxy to cloud processing environment.

In an embodiment, the B2B2C service is the B2B2C service 130.

In an embodiment, the B2B2C service is the shared service depicted in the center of the architecture 150 of the FIG. 1B.

In an embodiment, the B2B2C service is a combination of the B2B2C service 130 and the shared service depicted in the center of the architecture 150 of the FIG. 1B.

In an embodiment, the B2B2C service is an enhanced version of the method 200, presented in the FIG. 2.

In an embodiment, the B2B2C service is some combination of the B2B2C service 130, the shared service depicted in the center of architecture 150 of the FIG. 1B, and the method 200 of the FIG. 2.

At 310, the B2B2C service receives first preferences and first restrictions from a first business system associated with a first business. The preferences and restrictions can include a variety of configuration information that the first business is willing to accept for sharing purposes with a second business system associated with a second business system. Some of these preferences and restrictions were discussed above with the discussions of the FIGS. 1A and 1B.

For example, at 311, the B2B2C service receives the first preferences as one or more of: types of recommendations, types of promotions, and values of the promotions that are deemed acceptable to the first business system (first business).

In another example, at 312, the B2B2C service receives the first restrictions as one or more of: limits on the promotions and sizes for the promotions that are deemed necessary to restrict by the first business system (first business).

At 320, the B2B2C service also obtains second preferences and second restrictions from a second business system. The types of information received for the second preferences and second restrictions are the same as that which was discussed as having been received from the first business system, although the values and conditions for the second preferences and the second restrictions are different from the first preferences and the first restrictions.

After the first business system and the second business system have properly configured the B2B2C service with the preferences and the restrictions, at 330, the B2B2C service provides real-time and dynamic shared customer relationship management (CRM) processing between the first and second business systems with respect to customers of both the first and second business systems. This can include any of the processing discussed above with the FIGS. 1A and 1B.

In an embodiment, at 331, the B2B2C service provides an exposed interface to the first business system and the second business system for dynamically configuring and performing the shared CRM processing in real time with the B2B2C service.

According to an embodiment, at 332, the B2B2C service provides the shared CRM processing as one of more of: a shared promotion engine (for providing B2B promotions to shared customers), a shared campaign management engine (for marketing to shared customers), a shared reports engine (for generating reports relevant to promotions, recommendations, campaigns, etc.), a shared analysis engine (for identifying customer patterns and segmentation for potential campaigns), a shared optimization engine (optimizing available non-conflicting promotions provided), and a shared conflicts management engine (to resolve conflicting available or redeemable promotions).

In an embodiment, at 340, the B2B2C service delivers in real time a promotion from the second business system to a specific customer transacting in real time with the first business system based on an anticipated journey of the specific customer following the transaction with the first business system and further based on the shared CRM processing. This situation was discussed above with respect to the FIGS. 1A, 1B, and 2.

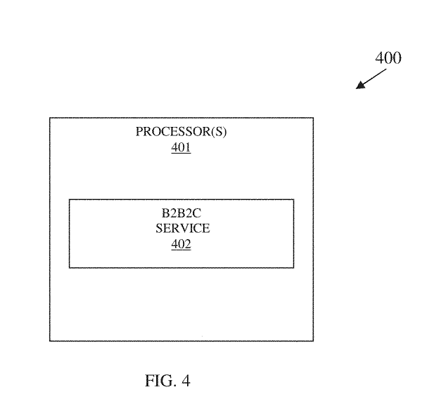

FIG. 4 is a diagram of a system 400 for B2B2C processing, according to an example embodiment. The system 400 includes a variety of hardware components and software components. The software components of the system 400 are programmed and reside within memory and/or a non-transitory computer-readable medium and execute on one or more hardware processors of a hardware device. The system 400 communicates one or more networks, which can be wired, wireless, or a combination of wired and wireless.

In an embodiment, the system 400 implements all, any, or some combination of the processing discussed above with the FIGS. 1A-1B and 2-3.

The system 400 includes at least one hardware processor 401 and B2B2C service 402.

In an embodiment, the hardware processor 401 is part of a server.

In an embodiment, the hardware processor is part of a cloud processing environment.

The B2B2C service 402 is configured to: execute on the processor 401, share CRM processing in real time between a first business system and the second business system, deliver in real time at least one promotion for the second business system to a customer transaction with the first business system based on the shared CRM processing. This can occur while a transaction is being conducted between the customer and the first business system or can occur in near real time such as while the customer is exiting the first business after just (a minute or less) completed the transaction with the first business.

In an embodiment, the B2B2C service 402 is further configured to identify the at least one promotion and the second business system based on an anticipated journey or pattern of behavior for the customer following a transaction between the customer and the first business system. This was discussed at length above and can be processed based on a transaction history of the customer, a resolved current location for the customer (based on the first business or based on the location of a consumer-operated device), known locations that the customer is likely to frequent (such as a home address, a work address, etc.) and generation of a route between the current location of the customer and the known locations that the customer is likely to frequent.

In an embodiment, the B2B2C service 402 is configured to one or more of: provide a customer segment for recommendations and promotions to the first business system and the second business system and update a campaign based on tracked results received from the first business system and the second business system.

In an embodiment, B2B2C service 402 is the B2B2C service 130.

In an embodiment, the B2B2C service 402 is the shared service in the center of the architecture 150 of the FIG. 1B.

In an embodiment, the B2B2C service 402 is the method 200 of the FIG. 2.

In an embodiment, the B2B2C service 402 is the method 300 of the FIG. 3.

In an embodiment, the B2B2C service 402 is deployed as a Software as a Service (SaaS) over a network.

In an embodiment, the B2B2C service 402 is configured to provide an interface to a customer device for interaction or interact with the customer through a POS terminal's interface of a business and request that the customer either affirmatively opt in or opt out of any B2B2C promotional offers received by the customers through the first and second business systems.

It is also noted that although the embodiments presented herein describe just two business systems in a one-to-one relationship providing B2B2C services, but the invention is not so limited. This was done for ease of comprehension and explanation. Therefore, the B2B2C services discussed herein can include one business (one business system) in a relationship to provide the aforementioned B2B2C service with many other businesses (two or more business systems). Similarly, the B2B2C services discussed herein can include many businesses (two or more business systems) with many other business (two or more other business systems).

In an embodiment, the exposed interfaces and services through the B2B2C embodiments discussed herein are used for interaction and collaboration between businesses and customers for purposes other than promotional arrangements, such as surveys, contests, idea testing, and many other purposes.

In an embodiment, the software described herein executes on a virtualized device or virtualized construct (containerization), where the virtualized device or virtualized construct (containerization) is layered on top of and processed by at least one hardware processor.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A method, comprising:
receiving transaction data for a customer in real-time from a first business system;
obtaining a recommendation or a promotion for a good or service available from a second business system based on the transaction data; and
causing the recommendation or he promotion to be delivered to the customer.

2. The method of claim 1, wherein receiving further includes identifying a location of the customer from the transaction data.

3. The method of claim 2, wherein obtaining further includes identifying the second business system based on an anticipated path that the customer is going to take after transacting with the first business system.

4. The method of claim 2, wherein obtaining further includes identifying the second business system based on an anticipated pattern that the customer is going to engage in after transacting with the first business system.

5. The method of claim 1, wherein obtaining further includes identifying the second business system by evaluating a history and profile for the customer that is shared between the first business system and the second business system.

6. The method of claim 1, wherein obtaining further includes deriving the recommendation or the promotion from a shared recommendation engine or a shared promotion engine that is shared between the first business system and the second business system.

7. The method of claim 1, wherein causing further includes delivering the recommendation or the promotion to a Point-Of-Sale (POS) terminal through which the customer is using for transacting with the first business system for delivery by the POS terminal to the customer.

8. The method of claim 1, wherein causing further includes directly delivering the recommendation or the promotion to a mobile device being operated by the customer.

9. The method of claim 1, wherein causing further includes delivering the recommendation or the promotion over a different communication channel from that which the customer is using for transacting with the first business system.

10. The method of claim 1, wherein causing further includes delivering the recommendation or the promotion over a communication channel defined in a customer profile shared between the first business system and the second business system.

11. The method of claim 1 further comprising, updating a shared campaign between the first business system and the second business system when the customer is detected as having followed the recommendation or redeemed the promotion with a terminal associated with the second business system.

12. A method, comprising:
receiving first preferences and first restrictions from a first business system;
obtaining second preferences and second restrictions from a second business system;
providing shared customer relationship management processing between the first business system and the second business system based on the first preferences, the first restrictions, the second preferences, and the second restrictions.

13. The method of claim 12, wherein receiving further includes receiving the first preferences as one or more of: types of recommendations, types of promotions, and value of the promotions acceptable to the first business system.

14. The method of claim 12, wherein receiving further includes receiving the first restrictions as one or more of: limits on the promotions and sizes for the promotions.

15. The method of claim 12, wherein providing further includes providing an exposed interface to the first business system and the second business system for configuring and performing the shared CRM processing.

16. The method of claim 12, wherein providing further includes providing the shared customer relationship management processing as one or more of: a shared recommendation engine, a shared promotion engine, a shared campaign management engine, a shared reports engine, a shared analysis engine, and a shared optimization engine.

17. The method of claim 12 further comprising, delivering in real time a promotion from the second business system to a specific customer transacting with the first business system based on an anticipated journey of the specific customer following a transaction with the first business system and based on the shared customer relationship management processing.

18. A system, comprising:
a hardware processor;
a Business-to-Business to Customer (B2B2C) service configured to: (i) execute on the hardware processor; (ii) share customer-relationship management processing in real time between a first business system and second business system, (iii) deliver in real time at least one promotion for the second business system to a customer transacting with the first business system based on the shared customer-relationship management processing.

19. The system of claim 18, wherein the B2B2C service is configured, in (iii) to: identity the at least one promotion and the second business system based on an anticipated journey or pattern of behavior for the customer following a transaction between the customer and the first business system.

20. The system of claim 18, the B2B2C service is configured to one or more of: provide a customer segment for recommendations and promotions to the first business system and the second business system and update a campaign based on tracked results received from the first business system and the second business system.
